(19) United States
(12) Patent Application Publication
(10) Pub. No.: US 2008/0060348 A1
(43) Pub. Date: Mar. 13, 2008

(54) Emissions reduction system

(75) Inventors: Wade J. Robel, Peoria, IL (US); James J. Driscoll, Dunlap, IL (US)

Correspondence Address: Caterpillar Inc.;Intellectual Property Dept., AB 6490, 100 N.E. Adams Street, PEORIA, IL, 61629-6490, US

(73) Assignee: Caterpillar Inc.

(21) Appl. No.: 11/517,918

(22) Filed: Sep. 8, 2006

(51) Int. Cl. F01N 5/04; F01N 3/00; F01N 3/10; F02B 33/44

(52) U.S. Cl. 60/295; 60/286; 60/297; 60/301; 60/280; 60/612

(57) ABSTRACT

An engine, an exhaust system, and a method for reducing NOx in an exhaust stream are provided. The system comprises a first SCR catalyst, a second SCR catalyst, and a particulate filter positioned between the first and second SCR catalyst. The engine comprises an intake air system, at least one combustion chamber, and an exhaust system comprising a first SCR catalyst positioned upstream of a particulate filter and a second SCR catalyst positioned downstream of the particulate filter. The method comprises the steps of passing the exhaust through a low-temperature SCR catalyst, passing the exhaust through a particulate filter, and passing the exhaust through a high-temperature SCR catalyst.

### TECHNICAL FIELD

The present disclosure relates generally to a system and method for reducing pollutants in an exhaust system and, more particularly, to a system for reducing nitrogen oxides (“NOx”) within the exhaust stream of an engine.

### BACKGROUND

Fuel-burning power plants, such as some furnaces and internal and external combustion engines, may emit pollutants such as carbon monoxides, NOx, particulate matters, and sulfur oxides, to name a few.

Many of these pollutants are regulated by governmental agencies, which mandate that engines-along with other fuel-burning plants-not exceed certain maximum limitations. In meeting these regulations, engine manufacturers are challenged with designing engines that both meet stringent exhaust regulations as well as provide fuel-efficient power conversion. Additionally, engine manufacturers have difficulty in designing engines that meet all of the regulations for the several different types of exhaust pollutants.

For diesel engines, two of the primary pollutants regulated are NOx and particulate matter. Particulate matter is composed of soot, soluble organic fraction (SOF), and sulfates. NOx, on the other hand, includes NO and NO2.

During the combustion process, a mixture of fuel and oxygen ignites. If excess oxygen is present, the local mixture is lean, and the combustion usually results in the emission of increased NOx. If excess fuel is present, the local mixture is rich, and the combustion will result in the emission of unburned hydrocarbon and soot. Consequently, most engines emit a mixture of NOx and particulate matter.

To reduce the amount of NOx, some engines are equipped with Selective Catalytic Reduction (“SCR”) systems that convert a mixture of NOx and ammonia into nitrogen gas and water. Unfortunately, many SCR systems are only capable of operating within a narrow temperature range. As a result, NOx is not converted when the exhaust stream is either too cold or too hot.

In addition to increased NOx formation during lean combustion, the formation of NOx increases as the temperature within the combustion chamber increases. At or above about 1350° C., the combustion of fuel results in the formation of NOx. As such, reducing the peak combustion temperature is another means for reducing NOx formation.

Exhaust gas recirculation (“EGR”) is a means for reducing NOx by reducing peak combustion temperatures. EGR involves recirculating some exhaust gas from the exhaust system to the intake system of the engine. As more exhaust gas is introduced to the intake air, peak combustion temperatures drop, thus providing for lower NOx formation.

To reduce the amount of particulate matters, on the other hand, some exhaust systems include particulate filters, which filter the particulate matters from the exhaust stream before being discharged into the environment.

U.S. Pat. No. 6,928,806 to Tennison et al. (“Tennison”) discloses a system having an oxidation catalyst coupled upstream of a urea-based SCR catalyst and a particulate filter coupled downstream of the SCR catalyst. Tennison discloses that placing the particulate filter last in the system reduces tailpipe ammonia emissions as well as prevents any thermal damage to the SCR catalyst due to particulate filter regeneration. The system of Tennison, however, has several shortcomings.

The present disclosure aims at overcoming many of the problems associated with the system of Tennison, including thermal damage to any SCR catalyst positioned downstream of a particulate filter. Further, the disclosed system provides for an engine that combines several different technologies and is capable of meeting several stringent exhaust regulations.

### SUMMARY OF THE INVENTION

In one embodiment of the present disclosure, an exhaust system for receiving exhaust gas is provided. The system comprises a first SCR catalyst, a second SCR catalyst, and a particulate filter positioned between the first and second SCR catalyst.

In another embodiment of the present disclosure, a diesel engine is provided. The engine comprises an intake air system, at least one combustion chamber, and an exhaust system, said exhaust system comprising a first SCR catalyst positioned upstream of a particulate filter and a second SCR catalyst positioned downstream of the particulate filter.

In even yet another embodiment of the present disclosure, an exhaust system for receiving exhaust gas is provided. The exhaust system comprises; a first SCR catalyst, a particulate filter coated with a second SCR catalyst, a first injector positioned upstream of the first SCR catalyst, and a second injector positioned upstream of the particulate filter coated with the second SCR catalyst.

### BRIEF DESCRIPTION OF THE DRAWINGS

FIG. 1 is a diagrammatic illustration of an engine according to an exemplary embodiment of the present disclosure, and

FIG. 2 is a chart showing NOx conversion as a function of temperature for various catalysts.

### DETAILED DESCRIPTION

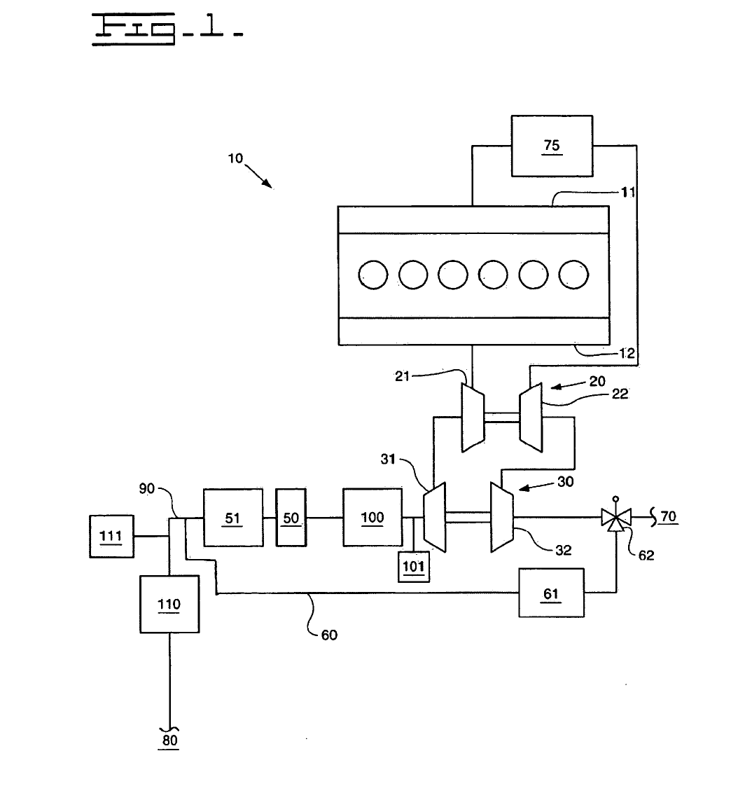

FIG. 1 illustrates an engine 10 according to an exemplary embodiment of the present disclosure. Although FIG. 1 depicts an engine 10, the reader should appreciate that the disclosed system for treating exhaust gas will apply to any exhaust stream where unwanted NOx or particulate matters are present. For example, any fossil-fuel burning power plant may also benefit from the disclosed system.

In this particular embodiment, engine 10 has intake manifold 11 and exhaust manifold 12. Intake air enters intake manifold 11 to facilitate the combustion within engine 10. Exhaust gas from the combustion process then exits via exhaust manifold 12.

The oftentimes high-temperature and high-pressure exhaust may then be used to drive a high-pressure turbocharger 20. In this case, exhaust gas drives turbine 21 to impart rotational energy to compressor wheel 22. Compressor wheel 22 is connected to turbine 21 via a common shaft. As the high-pressure exhaust drives turbine 21, the rotational energy imparted on compressor 22 helps pressurize intake air prior to entering intake manifold 11.

In some embodiments, it may be desirable to add a second turbocharger 30. Low-pressure turbocharger 30, like turbocharger 20, may have a turbine 31 and compressor 32 for further pressurizing the intake air.

In the particular embodiment of FIG. 1, once exhaust gas exits turbine 31, exhaust gas enters upstream catalyst 100 and then enters particulate filter 51, which may or may not be catalyzed. In this embodiment, a regeneration device 50 is positioned upstream of filter 51. Regeneration device 50 may be, for example, a burner configured to generate heat for regenerating filter 51. Alternatively, regeneration device 50 may be an oxidation catalyst or any heat-generating device. Furthermore, although device 50 is depicted as being upstream of filter 51, the reader should appreciate that, in some cases, the regeneration device—such as electrical heating elements, for example—may be positioned downstream of, adjacent to, or integral with filter 51.

As exhaust gas enters filter 51, soot, ash, and/or any other particulate material may be deposited within filter 51. Periodically, it may be desirable to regenerate filter 51 in order to burn any collected soot.

There are generally two types of filter regenerations: passive and active. Passive regeneration occurs when the soot within filter 51 burns without the addition of thermal energy, primarily through the reaction of carbon soot with NO2. If thermal energy is added to filter 51 to facilitate the burning of soot, the regeneration is considered active, and primarily involves soot oxidation by O2.

In this particular embodiment, regeneration may be initiated actively by regeneration device 50. Device 50 may be configured to generate heat to begin the regeneration of filter 51. During the regeneration of filter 51, an exothermic reaction occurs as the soot burns, resulting in high temperatures.

Positioned opposite both ends of filter 51 are catalysts 100 and 110. In at least some embodiments, upstream catalyst 100 may be a low-temperature SCR catalyst and downstream catalyst 110 may be a high-temperature SCR catalyst. The reader should appreciate, however, that catalysts 100 and 110 may comprise any type of SCR catalyst material. Furthermore, catalyst 100 and catalyst 110 may be the same type of SCR catalyst, comprising the same material.

Although FIG. 1 depicts upstream catalyst 100 as being upstream of filter 51, the reader should appreciate that in another embodiment, filter 51 is coated with a SCR catalyst. In this particular embodiment (not shown), by having filter 51 double as an SCR catalyst and a particulate trap, the need for a separate upstream catalyst 100 is eliminated.

SCR involves mixing exhaust air with a reductant, such as ammonia or urea, and passing the mixture over catalyst 100 or 110, which chemically converts the NOx. Catalysts 100 and 110 promote a reaction between NH3, NOx, and excess O2 in the exhaust stream, forming N2 and H20.

The reductant is introduced into the exhaust stream via injectors 101 and 111. Upstream injector 101 injects reductant into the exhaust stream upstream of catalyst 100. Downstream injector 111 injects reductant into the exhaust stream upstream of catalyst 110.

Although FIG. 1 depicts injectors 101 and 111 as being upstream and downstream of filter 51, respectively, the reader should appreciate that reductant may be injected at any point upstream of catalyst 110 and possibly upstream of catalyst 100. For example, reductant may be injected in exhaust manifold 12 and or in intake manifold 11.

Injecting reductant directly into intake manifold 11 may provide certain benefits. For example, because urea is approximately 66% water, the injected urea would act as a cooling dilutent, thus reducing NOx formation during the combustion process within the engine's 10 combustion chambers. Injecting urea into intake manifold 11 may also be beneficial as the urea would be at least partially converted to ammonia and thoroughly mixed with the exhaust gases before reaching catalyst 100 or 110.

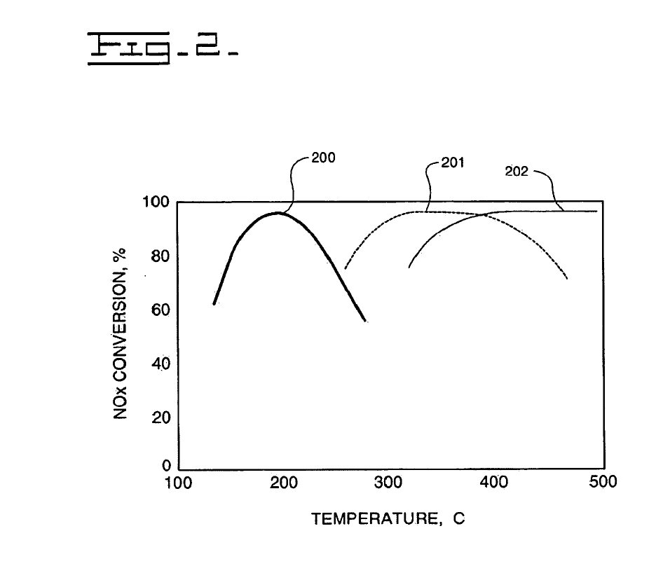

Downstream catalyst 110 may be a vanadia/titania 201 or zeolite-based 202 catalyst. As shown in FIG. 2, vanadia/titania 201 catalysts are effective at converting NOx from about 300° C. to about 400° C. Zeolite-based 202 catalysts can effectively convert NOx at temperatures up to about 500° C.

Upstream catalyst 100 may be a close-coupled catalyst, which is generally positioned proximal to the engine. In some embodiments, catalyst 100 may be a platinum-based 200 catalyst, which may be effective at converting NOx at around about 200° C. Although one embodiment provides catalyst 100 as being a platinum-based catalyst 200, the reader should appreciate that catalyst 100 may also be a zeolite-based catalyst 202, vanadia/titania-based catalyst 201, or any other catalyst known in the art.

In addition to being either a platinum-based catalyst 200, a vanadia/titania-based catalyst 201, a zeolite-based catalyst 202, or any other catalyst known in the art, catalyst 100 may be part of a diesel particulate filter or any known diesel-oxidation catalyst. Catalyst 100 may be composed, for example, of copper zeolites or iron zeolites.

By positioning a low-temperature catalyst in series with a high-temperature catalyst, engine 10 is capable of converting NOx throughout a broad temperature range. During low temperatures, such as around 200° C., the low-temperature catalyst will catalyze most of the NOx. During high temperatures, such as above 300° C., the high temperature catalyst will convert most of the NOx. Furthermore, injectors 101 and 111 may be controlled to only inject reductant when needed. For example, during high temperature operation, it may not be necessary for injector 101 to inject reductant if catalyst 100 is sufficiently warm.

In the particular embodiment disclosed in FIG. 1, recirculation line 60 is positioned downstream of injector 101. The reader should appreciate that this particular embodiment may result in the formation of excessive ammonium nitrate within recirculation line 60, cooler 61, cooler 75, or intake manifold 11, for example. Excessive formation of ammonium nitrate may detrimentally affect the operation of engine 10.

To correct the problem of ammonium nitrate formation within these components, it may be desirable to shut off injector 101 when catalyst 110 is within an acceptable temperature range for NOx conversion. If catalyst 110 is sufficiently warm, it may not be necessary to inject reductant to catalyst 100. In this operation, catalyst 110 may provide for sufficient NOx conversion to permit the disabling of injector 101. By disabling injector 101 of the particular embodiment of FIG. 1, ammonia would not be generally introduced into recirculation line 60 and, consequently, ammonium nitrate will not be generally formed.

Alternatively, the reader should appreciate that an internal EGR system may also be used in conjunction with the engine. As one skilled in the art would understand, an internal EGR system may use intake or exhaust variable valve actuation to recirculate exhaust gas into the combustion process of engine 10.

In addition to an internal EGR system, the reader should also appreciate that engine 10 may use a high-pressure loop EGR system (not shown). As one skilled in the art would understand, a high-pressure loop EGR system would, for example, recirculate exhaust gas upstream of turbine 21 or 31 and send it to the engine's 10 intake system from there.

Referring back to FIG. 1, in at least one embodiment, upstream catalyst 100 is a platinum-based catalyst. In addition to converting NOx to N2 and H20—in the presence of reductant NH3—platinum-based catalysts work as oxidation catalysts, converting NO to NO2. NO2 helps with the passive regeneration of soot within filter 51 at temperatures of around 300-500° C.

During the combustion process, most of the NOx formed is composed of NO and only about 5% of the NOx formed is composed of NO2. NO2 may be desirable as it helps with the passive regeneration of soot within filter 51. Within the temperature range of about 300-500° C., NO2 facilitates the burning of soot within filter 51. At higher temperatures, above around 500° C., for example, the soot burns in the presence of O2.

Furthermore, because platinum-based catalysts act as oxidation catalysts, they advantageously oxidize hydrocarbons and carbon monoxide, as well.

In at least one embodiment, downstream catalyst 110 is a zeolite-based catalyst. As previously mentioned, zeolite-based catalysts are effective at converting NOx at high temperatures, such as above around 400° C. Even if filter 51 is regenerated actively, which results in downstream filter 51 temperature of around 500° C., the zeolite-based catalyst can withstand the high temperature without damage while effectively catalyzing the NOx.

If filter 51 is regenerated only passively, on the other hand, without the aid of regeneration device 50, the exhaust will not reach as high of a temperature. In this instance, catalyst 110 may be a vanadia/titania-based catalyst. During passive regeneration of filter 51, the temperature does not reach those temperatures that may cause damage to vanadia/titania-based catalysts. Further, if upstream catalyst 100 is a platinum-based catalyst, there may be sufficient NO-to-NO2 conversion to allow filter 51 to regenerate passively and at low temperatures, without ever adding thermal energy.

Referring now to FIG. 2, FIG. 2 depicts NOx conversion efficiency as a function of temperature for platinum 200, vanadia/titania 201, and zeolite 202 based catalysts.

After exhaust gas exits downstream catalyst 110, some exhaust gas may enter gas induction line 60. In this particular embodiment, cooler 61 may then cool the exhaust gas that enters line 60. Cooler 61 may be any type of heat exchanger that is known in the art, such as a parallel-flow heat exchanger that uses engine 10 jacket water (not shown) as a heat sink.

In this particular embodiment, once exhaust gas exits cooler 61, control valve 62 may be actuated for regulating the amount of exhaust gas that mixes with ambient air 70. Control valve 62 permits for a controlled mixing of recirculated exhaust gas with ambient air 70 prior to entering compressors 32 and 22 of turbochargers 30 and 20, respectively.

After the pressurized mixture of ambient air 70 and recirculated exhaust gas leaves compressor 22, it may then be cooled in cooler 75. Cooler 75 may be any known heat exchanger known in the art. In one particular embodiment, cooler 75 is an air-cooled air cooler.

In some embodiments, crankcase air from engine 10 block may be vented (not shown). In other embodiments, which are also not shown, the crankcase ventilation may be vented to the engine's 10 intake line, to atmosphere, or the engine's 10 exhaust line-either upstream or downstream of filter. Further, the crankcase ventilation may be filtered to remove any engine 10 oil particulates.

Exhaust air that is not recirculated via line 60 may then discharged to environment 80.

### INDUSTRIAL APPLICABILITY

The disclosed emissions reduction system could be used for any fuel-burning power plant or engine, for example. Many engines, such as internal and external combustion engines, emit both NOx and particulate matters. The disclosed system may reduce both of these emitted pollutants before being emitted to the environment. Diesel engines, for example, may benefit from the disclosed system as diesel engine manufacturers struggle to meet stringent NOx and particulate matter regulations.

In the particular embodiment shown in FIG. 1., fuel is combusted in engine 10 and the combusted exhaust gases may then pass through one or two turbochargers 20 and 30. Afterwards, exhaust gas may then enter upstream catalyst 100, where some of the NOx may be converted to N2 and or water. To facilitate the conversion of NOx, a reductant, such as ammonia or urea, may be injected into the exhaust stream by injector 101. Injector 101 may only inject reductant if the temperature of the exhaust gas or catalyst 100 is within the range of efficient NOx conversion. For example, if catalyst 100 is a platinum-based catalyst, urea may only be injected during cold operations, such as below around 250° C.

Additionally, if catalyst 100 acts as an oxidation catalyst, as many platinum-based catalysts do, some NO may be converted to NO2. The NO2 may then be used to facilitate regeneration of soot within filter 51.

After leaving upstream catalyst 100, the exhaust gas may then pass through particulate filter 51. Filter 51 is configured to collect particulate matter from exhaust gas, such as soot or hydrocarbons. Once filter 51 collects any soot or hydrocarbons, filter 51 may regenerate to burn at least some of the filtered soot or hydrocarbons. As previously discussed, regeneration may occur actively or passively.

In the embodiment of FIG. 1, regeneration may be initiated actively with the addition of thermal energy from regeneration device 50. In at least one example, device 50 may be a burner configured to direct heat to filter 51, thus causing soot or hydrocarbons to burn within filter 51. As depicted, regeneration device 50 may be positioned upstream of filter 51. This burn results in the release of thermal energy, which may further increase the temperature of exhaust gas.

After leaving filter 51, the exhaust gas may then enter downstream catalyst 110. Downstream catalyst may be a high-temperature SCR catalyst, such as a zeolite or vanadium/titanium-based catalyst, where some of the NOx may be converted to N2 and/or water. To facilitate the conversion of NOx, a reductant, such as ammonia or urea, may be injected into the exhaust stream by injector 111. In at least one embodiment, injector 111 may only inject reductant if the temperature of the exhaust gas or catalyst 100 is within the range of efficient NOx conversion. For example, if catalyst 110 is a zeolite-based catalyst, urea or ammonia may only be injected hot operations, such as above around 400° C.

After leaving catalyst 110, some, all, or none of exhaust gas may then enter recirculation line 60, where it would be mixed with ambient air 70. Cooler 61 may also cool some or all of this exhaust gas prior to mixing with ambient air. In at least one example, cooler 61 may be a jacket-water-cooled parallel-flow heat exchanger. The reader should appreciate, however, that any heat exchanger known in the art may be used to cool exhaust gas within line 60. The reader should also appreciate that a cooler 61 is also not necessary.

Other embodiments of the disclosed engine 10 will be apparent to those skilled in the art from consideration of the specification. It is intended that the specification and examples be considered as exemplary only, with the true scope of the invention being indicated by the following claims.

1. An exhaust system for receiving exhaust gas, comprising:
a first SCR catalyst;
a second SCR catalyst; and
a particulate filter positioned between the first and second SCR catalyst; and
a device configured to generate heat for regenerating the particulate filter.

2. The exhaust system of claim 1, in which the first SCR catalyst is a platinum-based catalyst.

3. The exhaust system of claim 1, in which the first seeend SCR catalyst is a vanadium/titanium-based catalyst.

4. The exhaust system of claim 1, in which the first SCR catalyst is a low-temperature catalyst and the second SCR catalyst is a high-temperature catalyst.

5. (canceled)

6. The exhaust system of claim 1, further comprising a recirculation loop configured to recirculate exhaust gas to an intake line of an engine.

7. The exhaust system of claim 6, in which the recirculation loop is a low-pressure loop.

8. The exhaust system of claim 6, in which the recirculation loop is a high-pressure loop.

9. The exhaust system of claim 1, in which the particulate filter is catalyzed.

10. The exhaust system of claim 1, in which the second SCR catalyst is a zeolite-based catalyst.

11. The exhaust system of claim 2, in which the second SCR catalyst is a zeolite-based catalyst.

12. (canceled)

13. (canceled)

14. The exhaust system of claim 1, further comprising a first injector positioned upstream of the first catalyst.

15. The exhaust system of claim 14, further comprising a second injector positioned upstream of the second catalyst.

16. The exhaust system of claim 14, in which the first injector is configured to inject reductant in an intake manifold of an engine.

17. The exhaust system of claim 14, in which the first injector is configured to inject reductant in an exhaust manifold of an engine.

18. A diesel engine, comprising:
an intake air system;
at least one combustion chamber; and
an exhaust system, said exhaust system comprising a first SCR catalyst positioned upstream of a particulate filter, a second SCR catalyst positioned downstream of the particulate filter, and a device configured to generate heat for regenerating the particulate filter.

19. The diesel engine of claim 18, in which the intake air system is configured to receive at least some exhaust gas from the exhaust system.

20. The diesel engine of claim 18, in which the first SCR catalyst is a platinum-based catalyst.

21. The diesel engine of claim 18, in which the second SCR catalyst is a zeolite-based catalyst.

22. The diesel engine of claim 18, in which the second SCR catalyst is a vanadiumltitanium-based catalyst.

23. (canceled)

24. (canceled)

25. The diesel engine of claim 18, further comprising a first injector positioned upstream of the first SCR catalyst.

26. The diesel engine of claim 25, further comprising a second injector positioned upstream of the second SCR catalyst.

27. The diesel engine of claim 25, in which the first injector is configured to inject reductant into the engine's intake manifold.

28. (canceled)

29. The exhaust system of claim 1, in which the second SCR catalyst is a vanadium/titanium-based catalyst.

30. The exhaust system of claim 2, in which the second SCR catalyst is a vanadium/titanium-based catalyst.
